(19) United States
(12) Patent Application Publication
(10) Pub. No.: US 2008/0084325 A1
(43) Pub. Date: Apr. 10, 2008

(54) SYSTEM AND METHOD FOR PROVIDING POSITION INFORMATION BY USING MINI-MAP

(76) Inventors: Bong-Gon KIM, Seoul (KR); Yong-Hyun Lim, Suwon-si (KR); Kyung-Ho Chae, Seoul (KR); Yun-Je Oh, Yongin-si (KR)

Correspondence Address: CHA & REITER, LLC, 210 ROUTE 4 EAST STE 103, PARAMUS, NJ, 07652, US

(21) Appl. No.: 11/685,804

(22) Filed: Mar. 14, 2007

(30) Foreign Application Priority Data
Oct. 10, 2006 (KR) 98440/2006

(51) Int. Cl. G08B 17/10

(52) U.S. Cl. 340/686.1

(57) ABSTRACT

Disclosed is a system and method for providing position information by using a mini-map, the system including: a server for detecting and transmitting an image including an entire field and position information of at least one athlete and a ball; and a mobile communication terminal for displaying the image received from the server, and displaying the position information of the at least one athlete and the ball on a mini-map.

### CLAIM OF PRIORITY

This application claims priority to an application entitled “System And Method For Providing Position Information By Using Mini-map,” filed in the Korean Intellectual Property Office on Oct. 10, 2006 and assigned Serial No. 2006-98440, the contents of which are hereby incorporated by reference.

### BACKGROUND OF THE INVENTION

1. Field of the Invention

The present invention relates to a system and a method for providing position information by using a mini-map, which provide position information by using a mini-map for a predetermined area of a screen according to movement of athletes and a ball.

2. Description of the Related Art

Generally, a Location Based Service (LBS) denotes a service easily and rapidly providing a user on the move with various information relating to the position of the user through wireless and wired communication. A method of finding the current position of a customer may be largely classified as a network-based scheme for finding the position of a terminal by using the position of a base station, or a Global Positioning System (GPS) receiver-based scheme utilizing a GPS using satellites. In addition to the two schemes, a hybrid scheme using the two schemes or various application schemes based on the two schemes have been developed.

When broadcasting a sports game, the sole method for generally showing the positions of athletes and a ball is to transmit images obtained by directly photographing the athletes and the ball by cameras to a user. However, in general sports broadcasting, cameras do not always photograph the entire content of the game for transmission. That is, several cameras photograph movement of the athletes and the ball at various angles, and athletes are shown close-up. In such a case, it is possible to observe movement of athletes in detail and to enjoy a sports game more vividly. FIG. 1 is a diagram illustrating a general image of a closed-up soccer game.

In general sports broadcasting, an entire scene is photographed using several cameras, and athletes and important parts are also shown close-up, which result in an occurrence of insufficiency in terms of a viewer.

In the case of sports such as a soccer game, detained movement of athletes is important, but the position of all the athletes is also important. For example, when one athlete is finding a place to which a ball is to be passed, the entire position of all the athletes is important. Viewers want to know the position of an athlete intended for reception of the ball. When an entire scene is displayed, there are no problems. However, since an athlete occupying the ball is mainly closed-up by a camera, the athlete intended for reception of the ball is not always displayed. The representative example is misjudgment of an off side foul determination. Specifically, since determination of an off side foul depends on subjectivity of a line umpire who must determine if soccer athletes are located in an off side position while moving along the side line of a soccer field, right and wrong for determination of an off side foul by a line umpire frequently occurs.

### SUMMARY OF THE INVENTION

Accordingly, the present invention has been made to solve the above-mentioned problems occurring in the prior art and provides additional advantages, by providing position information using a mini-map for a predetermined area of a screen according to movement of athletes and a ball.

It is another aspect of the present invention to more easily become aware of position and movement of athletes through a mini-map of a screen.

In accordance with one aspect of the present invention, there is provided a system for providing position information by using a mini-map, the system including: a server for detecting and transmitting an image including an entire field and position information of athletes and a ball; and a mobile communication terminal for displaying the image received from the server, and displaying the position information of the athletes and the ball on a mini-map.

### BRIEF DESCRIPTION OF THE DRAWINGS

The above features and advantages of the present invention will be more apparent from the following detailed description taken in conjunction with the accompanying drawings, in which:

FIG. 1 is a diagram illustrating a general image of a closed-up soccer game;

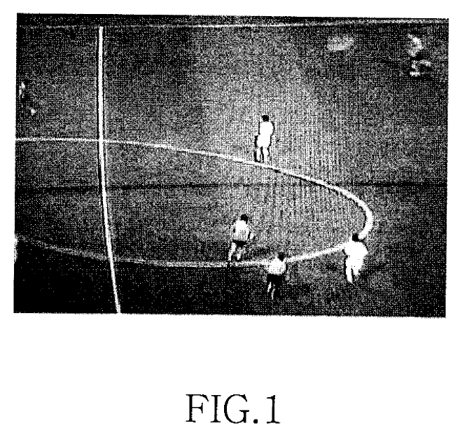

FIG. 2 is a block diagram illustrating the construction of a system for providing position information by using a mini-map according to an embodiment of the present invention;

FIG. 3 is a diagram illustrating parameters by which a system for providing position information calculates positions according to an embodiment of the present invention;

FIG. 4 is a diagram illustrating mini-maps with various sizes and positions in a system for providing position information according to an embodiment of the present invention;

FIG. 5 is a flow diagram illustrating a method for providing position information by using a mini-map according to an embodiment of the present invention; and

FIG. 6 is a diagram illustrating an image using a mini-map in a system for providing position information according to an embodiment of the present invention.

### DETAILED DESCRIPTION OF THE EMBODIMENT

An embodiment of the present invention is described in detail hereinbelow with reference to the accompanying drawings. For the purposes of clarity and simplicity, a detailed description of known functions and configurations incorporated herein is omitted when it may obscure the subject matter of the present invention.

A system for providing position information by using a mini-map, according to the present invention, includes a Digital Multimedia Broadcasting (DMB) phone, a Personal Digital Assistant (PDA), a smart phone, a Portable Multimedia Player (PMP), other mobile communication terminals, etc.

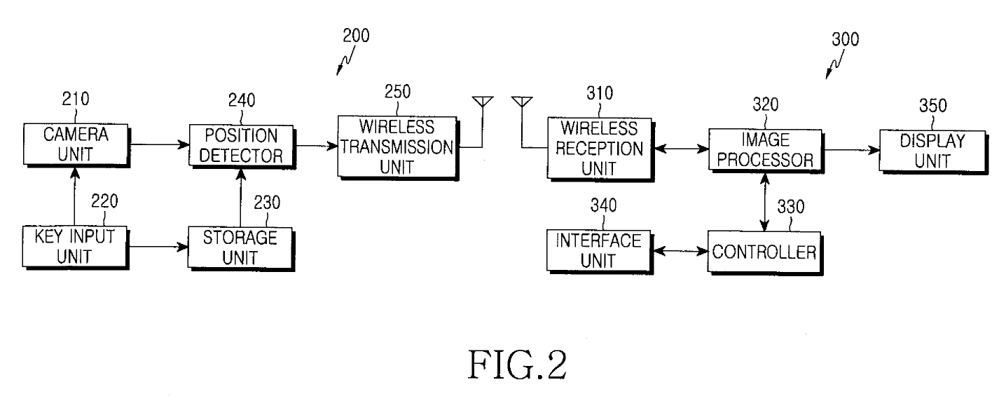

FIG. 2 is a block diagram illustrating an example of an architecture for a system for providing position information by using a mini-map according to an embodiment of the present invention.

As illustrated in FIG. 2, the system includes a server 200 and a mobile communication terminal 300. In the case of soccer, the server 200 photographs the entire image of a soccer field, detects position information therein of at least one athlete and a ball from the photographed image, and transmits the position information to the mobile communication terminal 300. The mobile communication terminal 300 displays the received position information according to the position and size of a mini-map.

In detail, the server 200 includes a camera unit 210, a key input unit 220, a storage unit 230, a position detector 240, and a wireless transmission unit 250.

The camera unit 210 has a detachable lens unit (not shown), and detects image data through the detachable lens unit. The camera unit 210 includes a camera sensor for converting detected optical signals into electrical signals, and a signal processor for converting analog image signals detected by the camera sensor into digital image data. The camera unit 210 photographs an image in which an entire soccer field is included in a single screen.

The key input unit 220 has a key matrix structure (not shown), which includes character keys, numeric keys, various function keys and an external volume key. The key input unit 220 outputs key input signals corresponding to keys input by a user to the camera unit 210 and the storage unit 230.

The key input unit 220 comprises operation keys of the camera unit 210 in predetermined positions according to an embodiment of the present invention, i.e. a power key of the camera unit 210 used when entering into a camera mode, a zoom key used for an adjusting zoom levels (i.e. magnification) of a camera lens module function, and a shutter key used for a detecting images function.

The storage unit 230 comprises a memory including a program memory and a data memory, and stores various information necessary for controlling the operation of the server 200 according to an embodiment of the present invention, and various information (absolute position display method and relative position display method) selected from images input from the camera unit 210 through the key input unit 220 by a user.

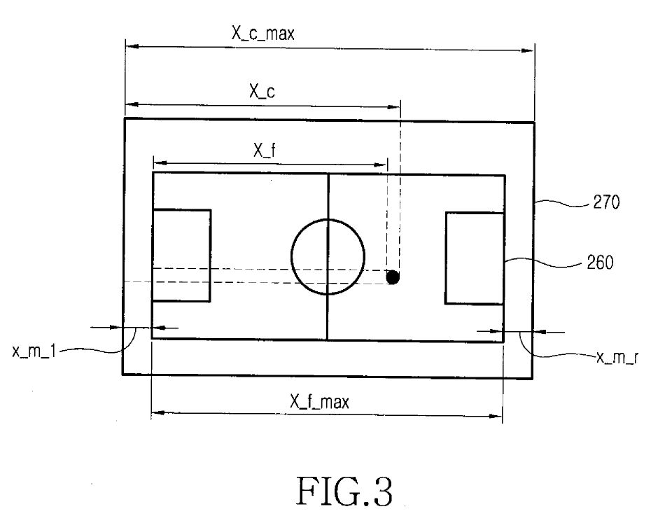

FIG. 3 is a diagram illustrating parameters by which the system for providing position information calculates positions according to an embodiment of the present invention.

As illustrated in FIG. 3, the position detector 240 detects position information of a ball and at least one athlete from the entire length of a soccer field 260 photographed by the camera unit 210 by using at least one of the methods selected from the group consisting of an absolute position display method for displaying actual coordinates of the ball and the at least one athlete and a relative position display method for displaying positions of the ball and the at least one athlete at a relative ratio.

When an x direction position in an entire image for the ball is defined as (x_c), and the x direction position of a left line of the soccer field 260 is defined as (x_m_l) according to the absolute position display method, the x direction position (x_f) of the ball is equal to {(x_c)−(x_m_l)}. If the x direction length of a camera screen 270 is defined as (X_c_max), and length between a right line of the soccer field 260 and a right end of the camera is defined as (x_m_r), the x direction length (X_f_max) of the soccer field 260 is equal to (X_c_max)−(x_m_l)−(x_m_r).

Since the server 200 and the mobile communication terminal 300 share the actual length of the soccer field 260, it is possible to calculate the actual position of the ball by using the calculated (X_f_max) and (x_f).

For example, when the soccer field 260 has a lateral length of 110 m, the actual position x of the ball is equal to (110*f_x)/(X_f_max). That is, when the lateral length of the soccer field 260 corresponds to 2000 pixels in the camera screen 270, and the calculated position of the ball corresponds to 750 pixels in the direction x, the absolute position x of the ball in the direction x is equal to 41.25 {=(110*750)/2000}.

Accordingly, the ball is currently located around 41.24 m in the soccer field 260. Calculation in a y direction is implemented in an analogous way. That is, since the absolute position display method calculates the actual position (unit: m) of the ball in consideration of the actual length of the soccer field 260, the position of the ball is calculated as position coordinate values for the ball. The position of the at least one athlete is also calculated in the same way.

It should be noted that since soccer fields can be different sizes, the server 200 and the mobile communication terminal 300 must share the fixed size of the soccer field 260 for the absolute position display method.

The relative position display method displays the position of a bail by using a ratio instead of displaying the actual length of the soccer field 260 by using coordinates, but is nearly similar to the absolute position display method, except for displaying the position of a ball by a percentage % when the length of the soccer field 260 is set to 100% (i.e. 1).

When the lateral length of the soccer field 260 is set to 100% (i.e. 1), the x direction coordinate {x=(f_x)/(X_f_max)} of the ball in FIG. 3 is calculated by {x=(f_x*100)/(X_f_max)} by using percentage.

For example, if (X_f_max) is 2000 pixels and (f_x) is 750 pixels, x is equal to 0.375 ( 750/2000). That is, the ball is located at the position corresponding to 37.5% in the x direction in the soccer field 260. Calculation in a y direction is implemented in an analogous way. This method is advantageous in that the server 200 and the mobile communication terminal 300 do not have to share the actual size of the soccer field 260. In other words, the relative position display method displays the position of a ball by a percentage % when the length of the soccer field 260 is set to 100% (i.e. 1), which calculates position information of the ball.

The wireless transmission unit 250 includes a Radio Frequency (RF) transmitter for transmitting the images input from the camera unit 210 and the position information calculated according to the movement of the at least one athlete and the ball, and up-converting and amplifying frequency signals for the calculated position information.

The mobile communication terminal 300 according to an embodiment of the present invention includes a wireless reception unit 310, an image processor 320, a controller 330, an interface unit 340, and a display unit 350.

The wireless reception unit 310 includes an RF receiver for low noise-amplifying and down-convening frequency signals for the position information of the athletes and the ball received from the server 200, etc.

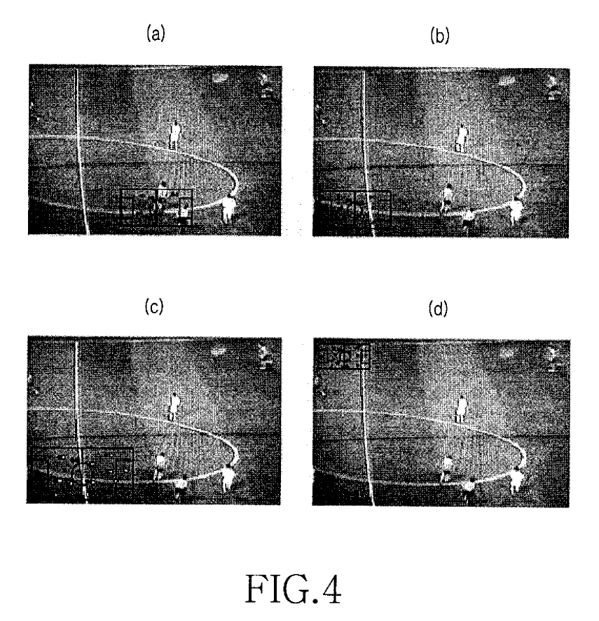

FIG. 4 is a diagram illustrating mini-maps with various sizes and positions in the system for providing position information according to the embodiment of the present invention.

As illustrated in FIG. 4, the image processor 320 outputs the images transmitted from the server 200 on the screen of the display unit 350 at a full size. Herein, the image processor 320 provides a mini-map based on the screen size of the display unit 350 according to shapes and sizes thereof requested by a user under the control of the controller 330. The user can select the position and size of the mini-map through a key input unit (not shown) as illustrated in FIGS. 4a to 4d. Further, the image processor 320 does not provide the mini-map by the user selecting an off function when the user does not want to watch the mini-map.

The controller 330 controls the general operation of the mobile communication terminal 300 according to an embodiment of the present invention. The controller 330 recalculates the position of the ball according to positions and sizes of the mini-map provided from the image processor 320. When the position coordinate value calculated by the absolute position display method is received from the server 200, if the received coordinate value corresponds to (x, y), the lateral length of the mini-map corresponds to (X_mini_max), and the actual lateral length of the soccer field 260 shared by the server 200 and the mobile communication terminal 300 corresponds to 110 m, the coordinate (x_mini) of the ball on the mini-map is calculated by {(X_mini_max*x)/110}. For example, when the lateral length of the mini-map is 80 pixels and the received x direction coordinate of the ball is 45 m, (x_mini) is equal to 32.72 {(80*45)/110}. That is, the ball is located around a position corresponding to 33 pixels in the x direction in the mini-map. A y coordinate is calculated in an analogous way, and the positions of athletes are also calculated in an analogous way.

When the position coordinate value calculated by the relative position display method is received from the server 200, if the received coordinate value corresponds to (x, y), and the lateral length of the mini-map corresponds to (X_mini_max), the coordinate (x_mini) of the ball on the mini-map is calculated by (X_mini_max*x). For example, when the lateral length of the mini-map is 80 pixels and the received x direction coordinate of the ball is 0.6, (x_mini) is equal to 48 (80*0.6). That is, the ball is located around a position corresponding to 48 pixels in the x direction on the mini-map. A y coordinate is calculated in an analogous way, and the positions of athletes are also calculated in an analogous way.

The controller 330 controls the display unit 350 to display the position information calculated according to the movements of the at least one athlete and the ball on the mini-map provided by the image processor 320 by using dots or shapes desired by a user, the position information being received from the wireless reception unit 310. The controller 330 controls the position information displayed on the mini-map to be displayed on the screen of an external display device through the wired interface unit 340 including a TV OUT, a USB, etc, and also controls the position information to be displayed on the screen of the external display device through the wireless interface unit 340 including Bluetooth, infrared data association, etc.

The display unit 350 displays the position information according to the movement of the athletes and the hall on the mini-map provided by the image processor 320.

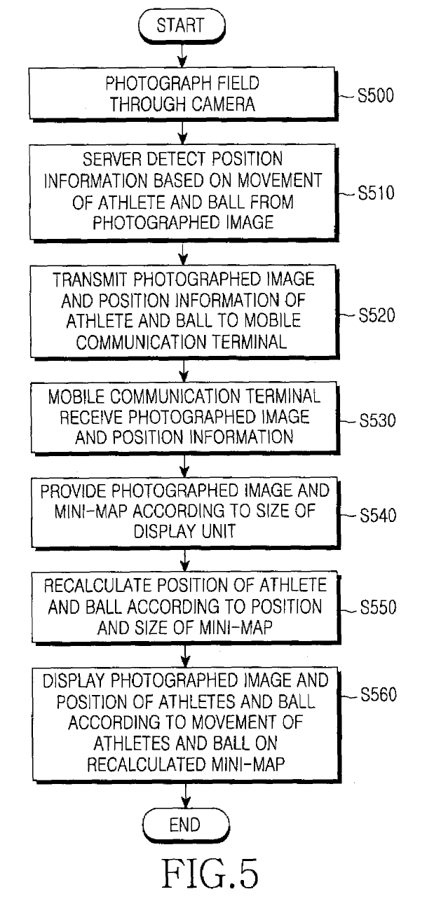

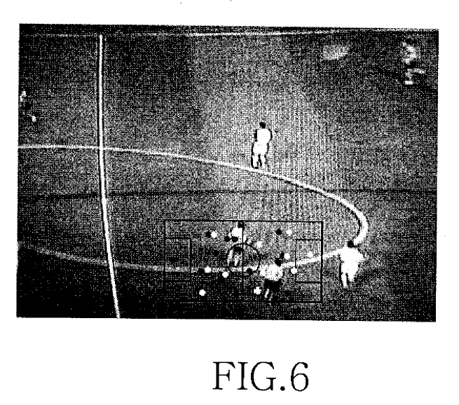

FIG. 5 is a flow diagram illustrating a method for providing position information by using a mini-map according to an embodiment of the present invention, and FIG. 6 is a diagram illustrating an image using a mini-map in a system for providing position information according to an embodiment of the present invention.

As illustrated in FIG. 5, the server 200 photographs an image through the camera unit 210 so that the soccer field 260 is fully included in a single screen (S500).

Then, coordinate values calculated for the actual positions (unit: m) of the at least one athlete and the ball are calculated from the entire image of the soccer field 260 photographed by the camera unit 210 through the absolute position display method stored in the storage unit 230 in consideration of the actual length of the soccer field 260, or the positions of the at least one athletes and the ball are calculated through the relative position display method when the length of the soccer field 260 is set to 100% (i.e. 1) (S510). That is, the position information based on the movement of the at least one athlete and the ball is calculated from the entire image photographed by the camera unit 210. Then, the image including the entire soccer field 260 and the position coordinate values calculated based on the movement of the at least one athlete and the ball are transmitted to the mobile communication terminal 300 through the wireless transmission unit 250 (S520).

The mobile communication terminal 300 receives the image including the entire soccer field 260 and the position coordinate values through the wireless reception unit 310 (S530). The image processor 320 outputs the images including the entire soccer field 260 on the screen of the display unit 350 at a full size, and provides a mini-map based on the screen size of the display unit 350 according to shapes and sizes thereof requested by a user (S540).

When the coordinate values calculated through a display method selected from the group consisting of the absolute position display method and the relative position display method are received from the server 200, the mobile communication terminal 300 recalculates the positions of the at least one athlete and the ball in consideration of positions and sizes of the mini-map provided from the image processor 320 (S550). The display unit 350 displays the image including the entire soccer field 260, and the positions of the athletes and the ball according to the movement of the at least one athlete and the ball on the mini-map (S560).

According to an embodiment of the present invention as described above, a mini-map is displayed in a predetermined area of a screen, so that it is possible to more easily become aware of the positions and movements of the at least one athlete and the ball. For example, in the case of a soccer game, it is possible to become aware of a space to which the at least one athlete will pass the ball, or the positions of the at least one athlete or ball at a glance.

Further, a foul such as an off-side, is more clearly visible using a mini-map, so that it is possible to watch a soccer game at a higher level of detail than without a mini-map.

Although a preferred embodiment of the present invention has been described for illustrative purposes, those skilled in the art will appreciate that various modifications, additions and substitutions are possible, without departing from the scope and spirit of the present invention as disclosed in the accompanying claims, including the full scope of equivalents thereof.

What is claimed is:

1. A system for providing position information by using a mini-map, the system comprising:
a server for detection and transmission of an image including an entire field and determination of calculated position information of at least one athlete and a ball therein; and
a mobile communication terminal for receipt and display of the image transmission from the server, and for display of the calculated position information of the at least one athlete and the ball on the mini-map.

2. The system as claimed in claim 1, wherein the server comprises:
a position detector for determination of calculated position information on the mini-map according to movements of the at least one athlete and the ball from an entire length of the field photographed by a camera unit by using a method selected from the group consisting of an absolute position display method for displaying actual coordinates of the at least one athlete and the ball on the mini-map and a relative position display method for displaying positions of the at least one athlete and the ball at a relative ratio on the mini-map; and
a wireless transmission unit for transmission of the calculated position information to the mobile communication terminal.

3. The system as claimed in claim 2, wherein the server further comprises a key input unit by which a user selects one display method from the group consisting of the absolute position display method and the relative position display method.

4. The system as claimed in claim 1, wherein the mobile communication terminal comprises:
an image processor for providing a mini-map for displaying thereon the calculated position information according to movements of the at least one athlete and the ball, the position information being received from the server;
a controller for recalculating the position information of the at least one athlete and the ball according to positions and sizes of the mini-map provided by the image processor; and
a display unit for displaying the recalculated position information of the at least one athlete and the ball on the mini-map.

5. The system as claimed in claim 4, wherein the image processor provides the mini-map based on a screen size of the display unit according to shapes and sizes thereof requested by a user.

6. The system as claimed in claim 4, wherein the controller recalculates the position information of the at least one athlete and the ball based on a display method selected from the group consisting of the absolute position display method or the relative position display method.

7. The system as claimed in claim 6, wherein when position information as a set of coordinate values calculated through the selected display method is received by the controller, the controller recalculates the positions of the at least one athlete and the ball in consideration of positions and sizes of a provided mini-map such that a display unit displays the image including the entire soccer field and the positions of the at least one athlete and the ball according to the movement of the at least one athlete and the ball on the mini-map.

8. The system as claimed in claim 7, wherein the controller controls the display unit to display the calculated position information of the at least one athlete and the ball by using dots or shapes desired by a user.

9. The system as claimed in claim 6, wherein the controller controls the display unit to display the calculated position information of the at least one athlete and the ball by using dots or shapes desired by a user.

10. The system as claimed in claim 4, wherein the mobile communication terminal displays the calculated position information displayed on the mini-map on a screen of an external display device through an interface unit.

11. A method for providing position information by using a mini-map, the method comprising the steps of:
inputting by a server an image including an entire field photographed through a camera;
calculating actual positions of at least one athlete and a ball as coordinate values based on movement of the at least one athlete and the ball from the photographed image through a method selected from the group consisting of an absolute position display method and a relative position display method;
transmitting the photographed image including the entire field and calculated position information based on the movement of the at least one athlete and the ball to a mobile communication terminal;
receiving by the mobile communication terminal the photographed image and the calculated position information;
outputting the received image at a full size of a screen, and providing a mini-map based on sizes of the screen according to shapes and sizes requested by a user;
recalculating the position information of the at least one athlete and the ball through a display method selected from the group consisting of the absolute position display method and the relative position display method in consideration of positions and sizes of the mini-map; and
displaying the image and the calculated positions of the at least one athlete and the ball on the mini-map based on the movements of the at least one athlete and the ball.

12. The method as claimed in claim 11, further comprising a step of displaying the position information of the at least one athlete and the ball by using dots or shapes selected by a user.
